(19) United States
(12) Patent Application Publication
(10) Pub. No.: US 2016/0331185 A1
(43) Pub. Date: Nov. 17, 2016

(54) A Food Preparation Board

(71) Applicant: Scott David Anderson, Oxenford (AU)

(72) Inventor: Scott David Anderson, Oxenford (AU)

(21) Appl. No.: 15/109,446

(22) PCT Filed: Dec. 31, 2014
(86) PCT No.: PCT/AU2014/001175

§ 371 Date: Jul. 1, 2016

(30) Foreign Application Priority Data
Jan. 2, 2014 (AU) 2014900004

(51) Int. Cl. A47J 47/00

(52) U.S. Cl. CPC A47J 47/005

(57) ABSTRACT

A food preparation board includes a food preparation portion, a discharge portion and a chute. The food preparation portion defines a surface suitable for supporting food on which food preparation activities are to be performed, The discharge portion defines a discharge opening through which food from the surface can be discharged. At least two attachment formations are located about a periphery of the discharge portion. Each attachment formation defines an aperture through which a portion of a bag can be threaded and an anchor formation adjacent the aperture, on to which said portion of the bag can be anchored. The chute is removably seated in the discharge opening. The chute extends into a mouth opening of the bag, in use.

### FIELD

The invention relates to a food preparation board. More particularly, but not exclusively, the invention relates to a food preparation board, such as a kitchen chopping board for use in carrying out food preparation activities such as chopping food and discarding of waste and scraps of food.

### BACKGROUND

Food preparation boards, such as chopping boards (also known as cutting boards) are well-known for use in the kitchen to prepare food. Chopping boards generally have a cutting surface on which the food is chopped or cut. Scraps of waste food are generally moved to one area of the cutting surface during food preparation. The user might then carry the chopping board to a bin to discard the scraps. The general procedure is to tilt the chopping board to the bin and sweep the scraps of food with a knife from the chopping surface into the bin.

The scraps sometimes fall off the chopping board as it is carried or moved to the bin. This necessitates cleaning of the floor or bench top. Additionally, when a lot of food is being prepared, frequent trips to discard the scraps are necessary, as scraps take up usable space on the cutting surface.

One example of a food preparation board, having a built-in container into which chopped food or waste can be directly transferred, is the Ergoplan chopping board available from Matfer Bourgeat Inc. (http://www.matferbourgeatusa.com/ergoplan-choppingboard-withbuilt-in-container-2).

The Ergoplan chopping board is shown in FIG. 1 of the drawings. The base board of the Ergoplan chopping board is raised on a set of feet to allow space for the built-in container. The container is removable from the base board.

Another example of a cutting board is described in PCT International Publication No. WO 97/40730 to Sanguinetti. The Sanguinetti cutting board has a recess through which waste can be swept into a bag. The bag is held relative to the recess by notches in the side of the Sanguinetti cutting board.

### SUMMARY

In accordance with one embodiment, there is provided a food preparation board including:
a food preparation portion that defines a surface suitable for supporting food on which food preparation activities are to be performed;
a discharge portion that defines a discharge opening through which food from the surface can be discharged; and
at least two attachment formations about a periphery of the discharge portion, each attachment formation defining an aperture through which a portion of a bag can be threaded and an anchor formation adjacent the aperture, on to which said portion of the bag can be anchored.

The food preparation board may include a chute that is mounted in the discharge portion in a fixed or removable manner to extend operatively downwardly from the discharge portion. Thus, the chute can extend into a mouth opening of the bag, in use.

The discharge portion may be configured so that the chute can be removably seated in the discharge opening.

The chute may have a flange for removably seating the chute in the discharge opening.

The discharge portion may have a rim that is peripheral to the discharge opening. The flange of the chute may be operable to rest on the rim when the chute is seated in the discharge opening. The flange may have a downwardly extending lip and the rim may have a corresponding groove for receiving the lip.

The food preparation board may include a weight arranged in or on the food preparation portion. The weight may be a counter weight for the discharge portion in those embodiments in which the discharge portion extends cantilever-fashion, from the food preparation portion.

In accordance with another embodiment, a food preparation board includes:
a food preparation portion that defines a surface suitable for supporting food on which food preparation activities are to be performed;
a discharge portion that defines a discharge opening through which food from the surface can be discharged;
at least two attachment formations about a periphery of the discharge portion, the attachment formations configured for releasable attachment of a bag so that a mouth opening of the bag is open to the discharge opening; and
a chute removably mounted in the discharge portion to extend operatively downwardly from the discharge portion and into the mouth opening of the bag, in use

In accordance with another embodiment, a method of attaching a bag to a food preparation board having a discharge portion that defines a discharge opening through which food can be discharged, includes:
threading a portion of the bag through an aperture of an attachment formation about a periphery of the discharge portion; and
anchoring the portion of the bag to an anchor formation of the attachment formation.

The portion of the bag may be looped around the anchor formation to anchor to the anchor formation.

The portion of the bag may be threaded through the aperture a sufficient extent so that a chute extending operatively downwardly from the discharge portion is received in a mouth opening of the bag.

Food preparation activities performed on the surface of the food preparation portion includes slicing, cutting, chopping, coring, grating and dicing of foodstuff.

A typical bag to be attached to the food preparation board comprises one or more flexible sidewalls defining a cavity in which goods can be held and flexible bottom which closes off one end of the bag, The bag has a mouth opening through which goods are inserted into the bag. Bags may include flexible handles.

Embodiments of the invention are now described, by way of example, with reference to the accompanying drawings.

### DESCRIPTION OF THE DRAWINGS

FIG. 1 shows a photograph of the prior art Ergoplan chopping board, in use.

FIG. 2 shows a three dimensional view, from one end, of an exemplary embodiment of a food preparation board.

FIG. 3 shows a three dimensional view of the food preparation board from the other end.

FIG. 4 shows a top view of the food preparation board.

FIG. 5 shows a side view of the food preparation board.

FIG. 6 shows a cross sectional side view of the food preparation board, sectioned along section line VI-VI of FIG. 4.

FIG. 7 shows a three dimensional sectional view of the food preparation board sectioned along section line VI-VI of FIG. 4.

FIG. 8 shows a three dimensional view of the body of the food preparation board.

FIG. 9 shows a cross sectional side view of part of the body, sectioned along section line IX-IX of FIG. 8.

FIGS. 10 to 12 show three dimensional views of the sequence of attaching a bag to the discharge portion of the food preparation board.

FIG. 13 shows a three dimensional view of a bag attached to the discharge portion, in use with the food preparation portion supported on a bench top.

FIG. 14 shows a three dimensional view of another method of attaching a bag to the discharge portion, in use.

FIG. 15 shows a three dimensional view of yet another method of attaching a bag to the discharge portion, in use

FIG. 16 shows a three dimensional view of the food preparation board and a handle-less bag to be attached to the discharge portion.

FIG. 17 shows a three dimensional view of a handle-less bag attached to the discharge portion of the food preparation board of FIG. 16, in use.

FIG. 18 shows a three dimensional view of a container seated in the discharge portion of the food preparation board of FIG. 8.

FIG. 19 shows a cross sectional side view of the container and discharge portion, sectioned along section line XIX-XIX of FIG. 18.

FIG. 20 shows a three dimensional view of another exemplary embodiment of a food preparation board.

FIG. 21 shows another three dimensional view of the food preparation board of FIG. 20.

FIG. 22 shows a cross sectional side view of the discharge portion of the food preparation board of FIG. 20, sectioned along section line XXII-XXII of FIG. 20.

FIG. 23 shows a three dimensional view of the underside of the food preparation board of FIG. 20.

FIG. 24 shows a three dimensional view of yet another exemplary embodiment of a food preparation board.

### DESCRIPTION OF THE EMBODIMENTS

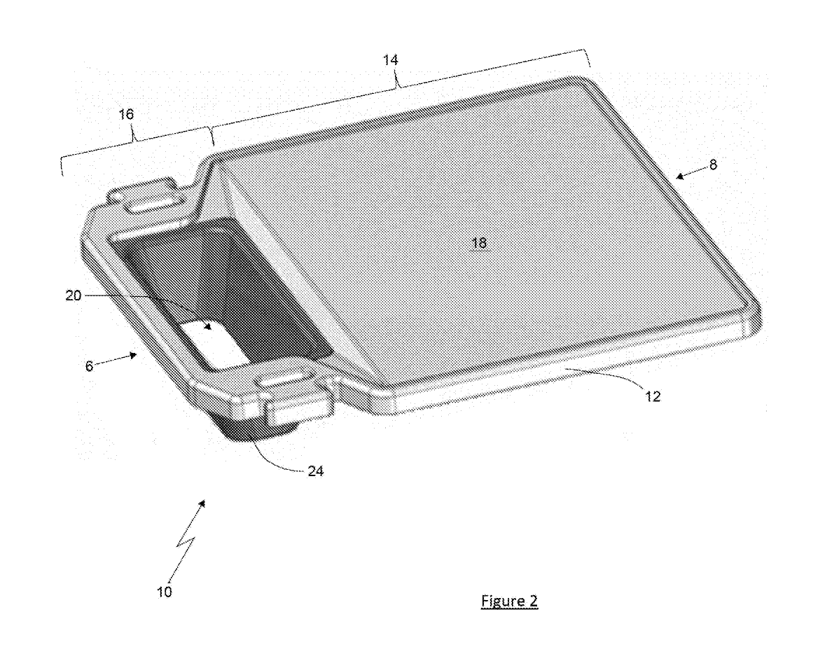

In the drawings, reference numeral 10 generally indicates one exemplary embodiment of a food preparation board in the form of a chopping board. FIG. 2 shows the food preparation board 10 comprising a body 12 and a chute 24. The body 12 comprises a food preparation portion 14 and a discharge portion 16. The chute 24 is mounted in the discharge portion 16. The chute 24 seats in a discharge opening 20 in the discharge portion 16. The food preparation board 10 has a discharge end 6 at an end of the discharge portion 16 and an opposite distal end 8 at the food preparation portion 14.

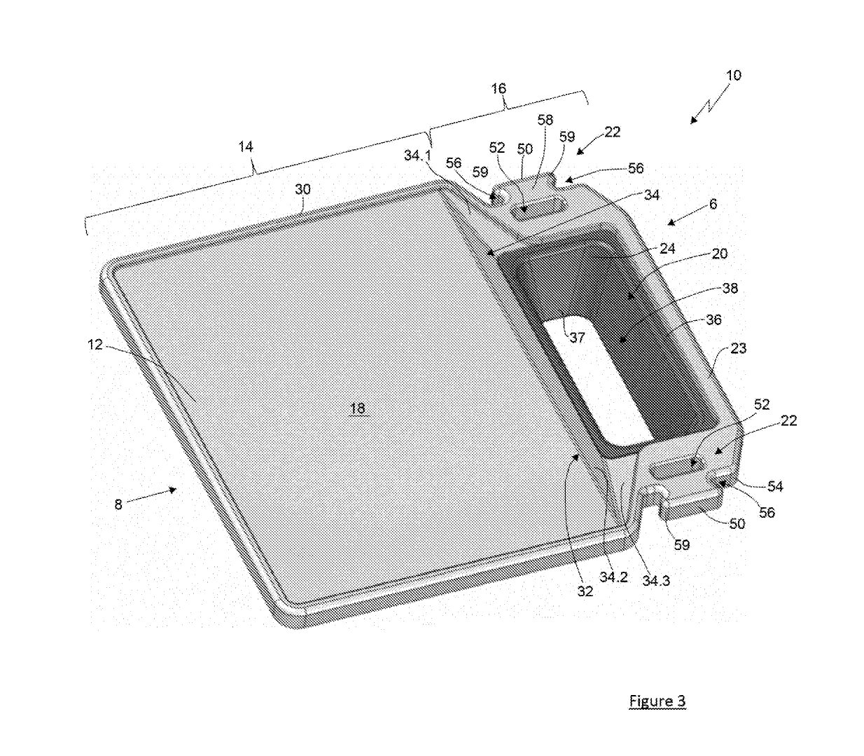

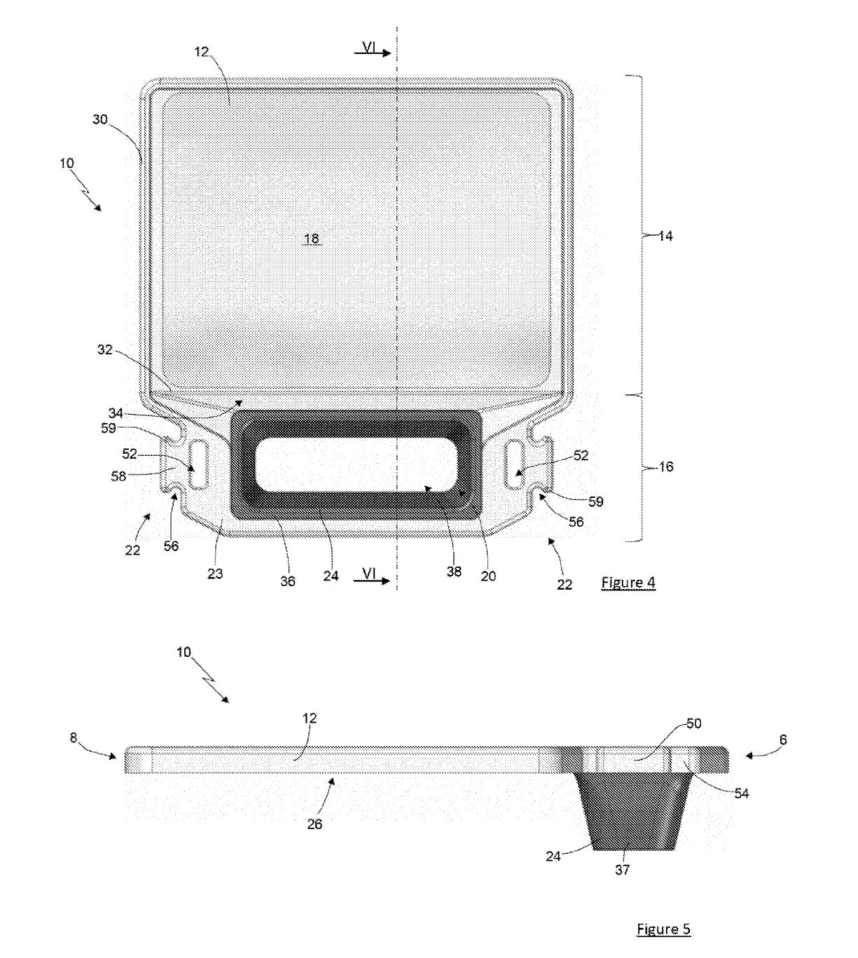

With reference to FIGS. 3 to 5, the food preparation portion 14 has an upwardly facing cutting surface 18. The body 12 includes a fastening system in the form of two attachment formations 22 about a periphery of the discharge portion 16. The chute 24 is removably seated in the discharge opening 20 of the discharge portion 16.

The cutting surface 18 is generally flat and square, The cutting surface 18 may comprise a removable insert (not shown). An upstanding edge 30 of the food preparation portion 14 surrounds three sides of the cutting surface 18. The cutting surface 18 extends to the discharge portion 16. The cutting surface 18 meets the discharge portion 16 at a border 32 between the food preparation portion 14 and the discharge portion 16. The upstanding edge 30 does not extend across the border 32, allowing food or scraps to be freely swept from the cutting surface 18 to the discharge opening 20. The body 12 may be of any suitable material that is rigid and which can easily be cleaned, such as wood, glass, or plastics material such as polypropylene, polyethylene, nylon, high-density polyethylene or corian. The body 12 is preferably injection molded from plastics material.

An inclined wall 34 or ramp of the body 12 leads down from the cutting surface 18 to the discharge opening 20. The wall 34 has three faces 34.1, 34.2 and 34.3 along which food or scraps can slide down to the discharge opening 20.

The discharge opening 20 is generally rectangular. A longitudinal side of the discharge opening 20 is parallel with the border 32. The width of the discharge opening 20 measured between the opposite sides 25 of the discharge opening 20 is less than the width of the cutting surface 18.

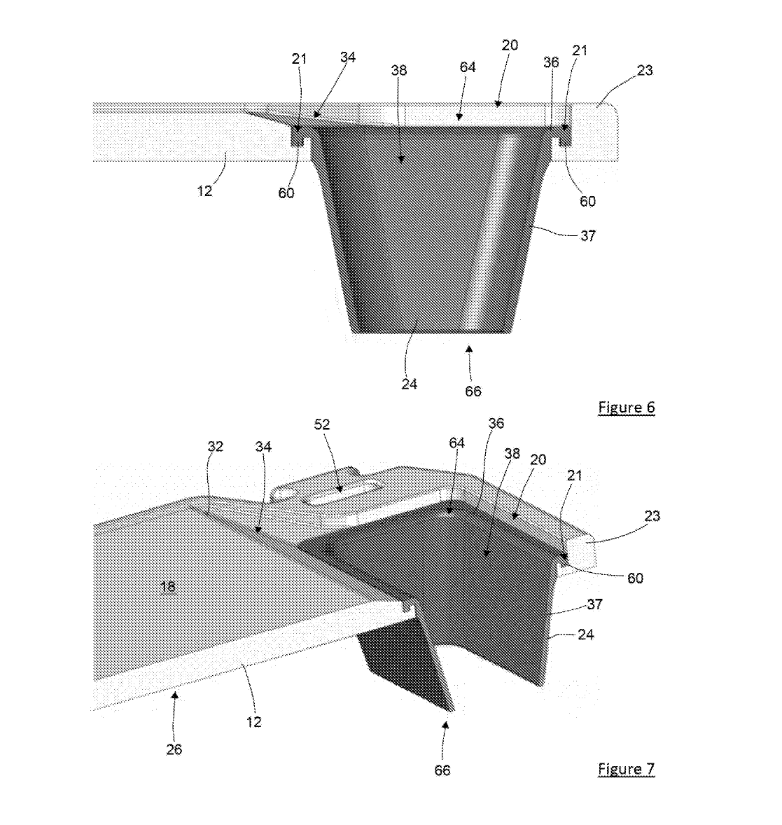

The chute 24 is a removable insert located within the discharge opening 20. In another embodiment the chute 24 may be integral with the discharge portion 16. The chute 24 comprises a flange 36 and a skirt 37. The skirt 37 extends operatively downwardly from the flange 36. The flange 36 abuts the inclined wall 34. The skirt 37 defines a passage 38 through which discharged food or scraps pass. Food or scraps sliding down the faces 34.1, 34.2 and 34.3 of the wall 34 pass over the flange 36 of the chute 24 and into the passage 38 of the chute 24. The chute 24 may be of any suitable material, for example a resiliently deformable material such as plastics or silicone that is also washable, or a rigid material such as stainless steel. The chute 24, and how the chute 24 is seated in the discharge opening 20, is described in more detail with reference to FIGS. 6 and 7.

The attachment formations 22 each comprise a hook or anchor formation 50 and an aperture 52. The attachment formations 22 are located externally about a periphery of the discharge portion 16. More specifically, the respective attachment formations 22 are spaced from opposite ends 25 of the discharge opening 20.

The apertures 52 are in the form of bounded slots that extend along the opposite sides of the discharge opening 20.

The discharge portion 16 has a surround or rim 23 peripheral to the discharge opening 20. The attachment formations 22 are integral with the rim 23. The apertures 52 of the attachment formations 22 are located opposite each other across the discharge opening 20. Each aperture 52 is spaced a distance from an opposite side 25 of the discharge opening 20. The apertures 52 are thus spaced a distance from each other which is wider than the width of the discharge opening 20.

The anchor formations 50 project outwardly from sides 54 of the body 12 at the discharge portion 16. Each anchor formation 50 is generally T-shaped, having a pair of opposite notches 56. The anchor formation 50 comprises a shank 58 in which the notches 56 are formed and horns 59 at the distal end of the shank 58. The horns 59 extend away from each other. It will be appreciated that the anchor formations 50 may alternatively be in the form of hooks, bosses, bollards, cleats or spigots that project from the sides 54 of the discharge portion 16. Anchor formations are any formations to which a portion of a bag can be anchored, tied or otherwise attached.

Each aperture 52 is adjacent a respective anchor formation 50. Each aperture 52 is located in the rim 23 between a respective anchor formation 50 and the discharge opening 20.

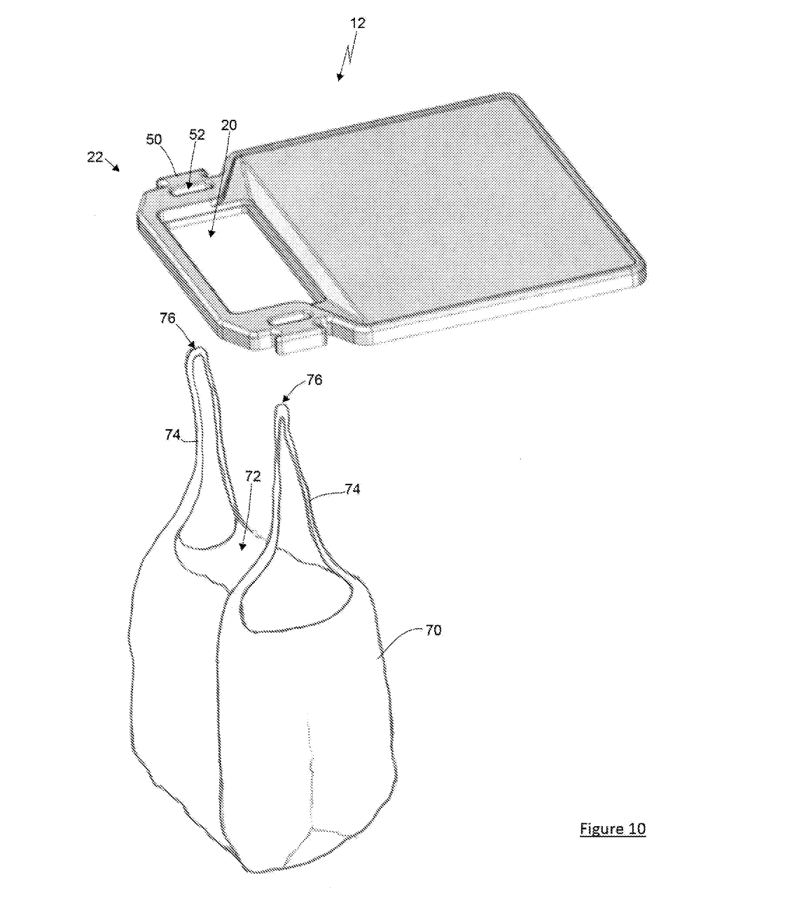

The attachment formations 22 are each configured for releasable attachment of the flexible handles or other portions of a bag. The manner in which handles of the bag are attached to the attachment formations 22 is described in more detail with reference to FIGS. 10 to 17.

Referring to FIGS. 6 and 7, the flange 36 of the chute 24 has a downwardly extending lip 60. The discharge portion 16 has a groove 21 in the rim 23. The lip 60 is dimensioned and configured to seat in the groove 21. The lip 60 of the chute 24 is received in the groove 21 of the rim 23 when the chute 24 is mounted in the discharge portion 16, in use. The chute 24 is supported in the discharge opening 20 by the flange 36 of the chute 24 resting on the rim 23 of the discharge portion 16.

The chute 24 has an inlet 64 to the passage 38 at the same end of the skirt 37 as the flange 36. The chute insert 24 has an outlet 66 at a lower end of the skirt 37, distal from the flange 36. The skirt 37 tapers inwardly from the inlet 64 to the outlet 66. The passage 38 thus narrows from the inlet 64 to the outlet 66.

The height of the chute 24 from its inlet 64 to its outlet is between 40 mm and 100 mm, for example 70 mm. The discharge portion 16 is between 10 mm and 30 mm thick, for example 18 mm thick. The distance which the chute 24 extends below the underside 26 of the discharge portion is between 30 mm and 90 mm, for example 60 mm.

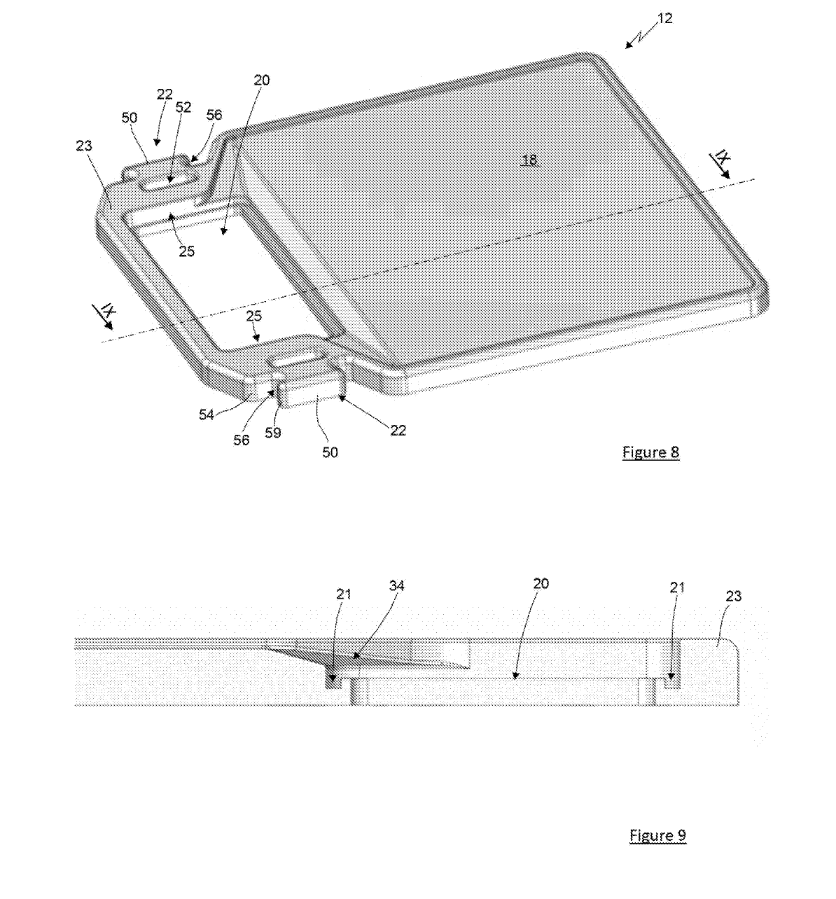

FIGS. 8 and 9 show the body 12 of the food preparation board 10. In particular the rim 23 of the discharge portion 16 surrounding the discharge opening 20 is clearly shown in FIG. 8. The groove 21 in the rim 23 is clearly shown in FIG. 9.

Referring to FIGS. 10 to 12, the steps of releasably attaching a disposable bag 70 to the discharge portion 16 of the food preparation board 10 is shown in sequence. The bag 70 has a mouth opening 72 and two handles 74 or slings. Any bag having flexible handles will suffice, but disposable plastic bags (also known as “bin bags” or “bin liners”) or plastic shopping bags of the “singlet” type, having looped handles, are preferred for use with the food preparation board 10.

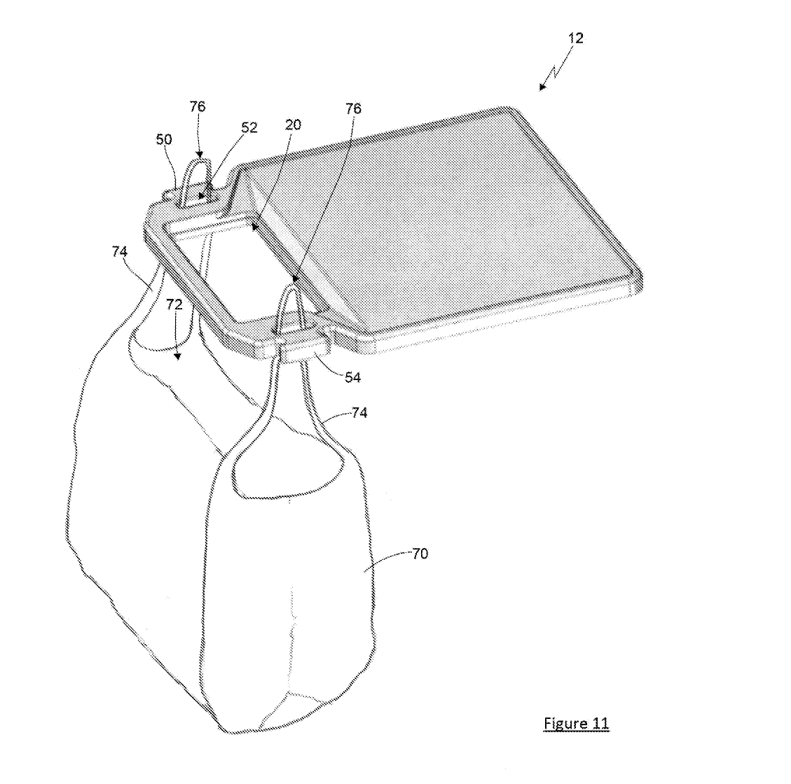

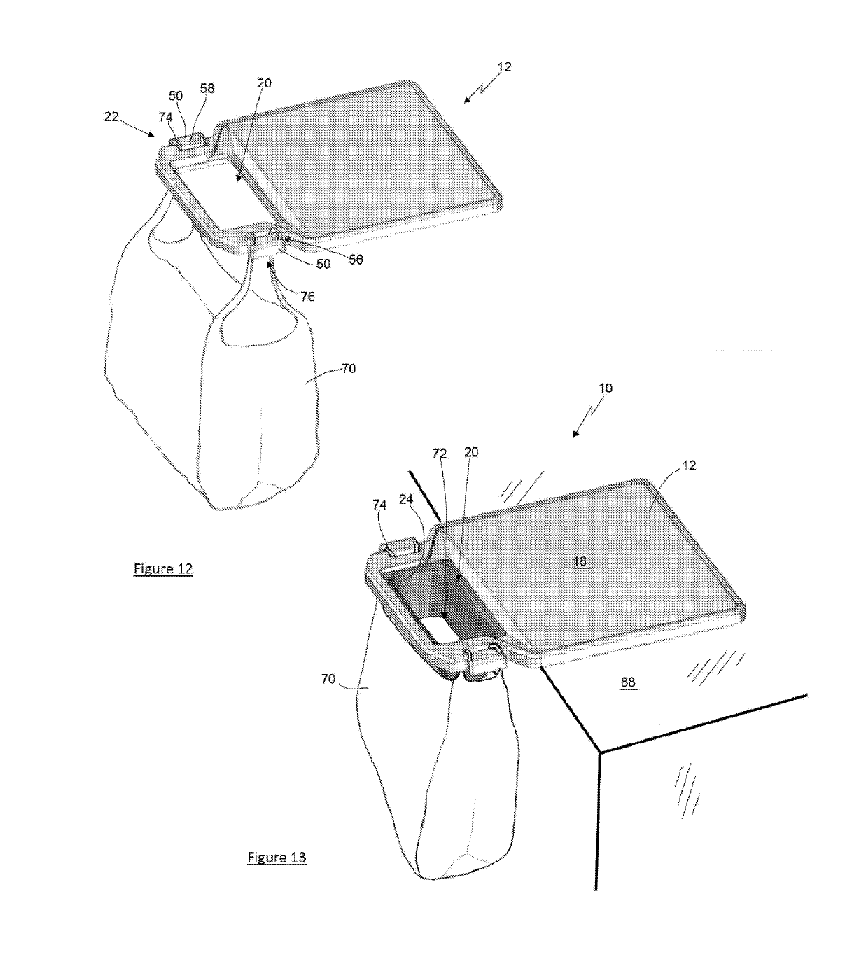

As shown in FIG. 10, upper ends 76 of the handles 74 are aligned with the apertures 52 of the attachment formations 22. The upper ends 76 are threaded through the apertures 52, so that the handles 74 extend at least partially through the apertures 52, as shown in FIG. 11. The upper ends 76 of the handles 74 are then looped around the anchor formations 50 in an attached condition of the bag 70 as shown in FIG. 12. The handles 74 are received in the notches 56 of the anchor formations 50. The handles 74 loop. wrap or tie to the anchor formations 50 to anchor the bag 70 to the discharge portion 16.

To release the bag 70 from the body 12, the handles 74 are unhooked from the anchor formations 50. Pulling the bag 70 downwardly (or lifting the body 12 upwardly) will pull the handles out of the apertures 52, leaving the bag 70 free to be discarded with its contents.

FIG. 13 shows the food preparation board 10, in use. The bag 70 is attached to the discharge opening 16. The chute 24 extends downwardly and into the mouth opening 72 of the bag 70. The handles 74 are threaded through the apertures 52 a sufficient extent so that the chute 24 extends into and is received in the mouth opening 72 of the bag 70. The mouth opening 72 of a thin plastic bag 70 is prone to collapsing or closing. Having the chute 24 extend into the mouth opening 72, so that the outlet 66 of the chute 24 is within the cavity of the bag 70, is useful to ensure that food and scraps exiting the chute 24 are ejected into the bag 70 as opposed to missing the mouth opening 72.

FIG. 14 shows another method of attaching the bag 70 to the food preparation board 10. The handles 74 pass through the apertures 52 and are then wrapped around the shanks 58 of the anchor formations 50. This method may be employed when the bag handles 74 are quite long and so lengths of the handles 74 are wrapped around the shanks 58 to shorten the distance between the mouth opening 72 of the bag 70 and the discharge opening 20.

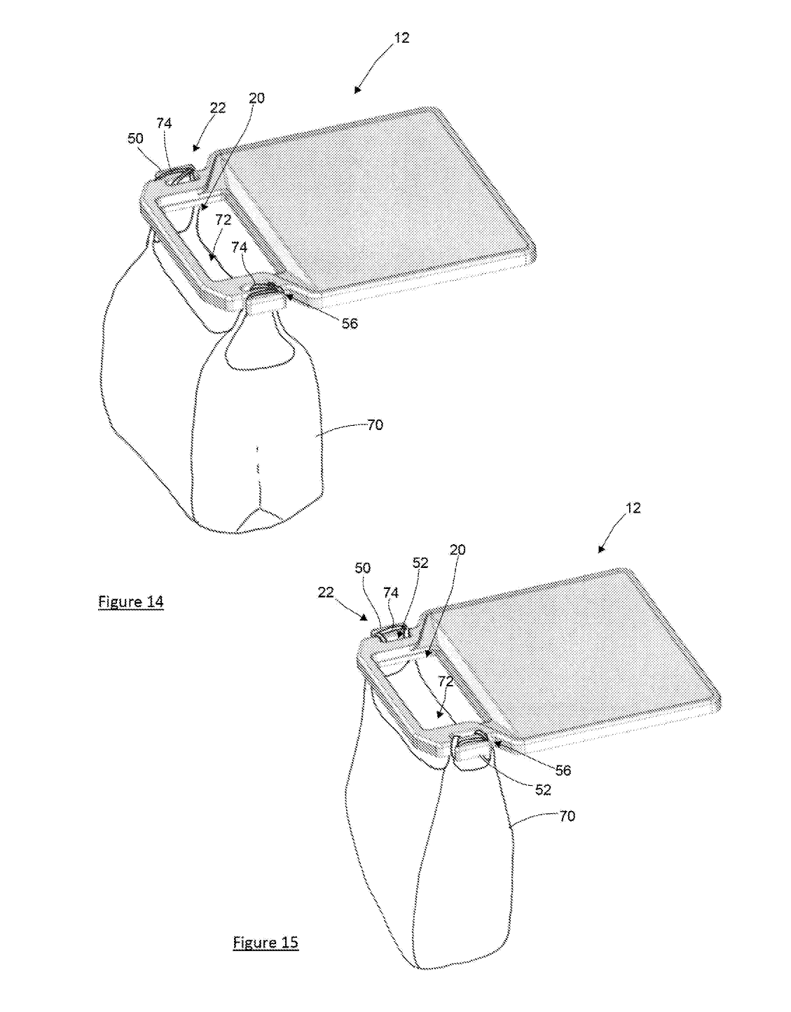

FIG. 15 shows yet another method of attaching the bag 70 to the food preparation board 10. The handles 74 are looped around the anchor formations 50 multiple times to shorten the distance between the mouth opening 72 and the discharge opening 20.

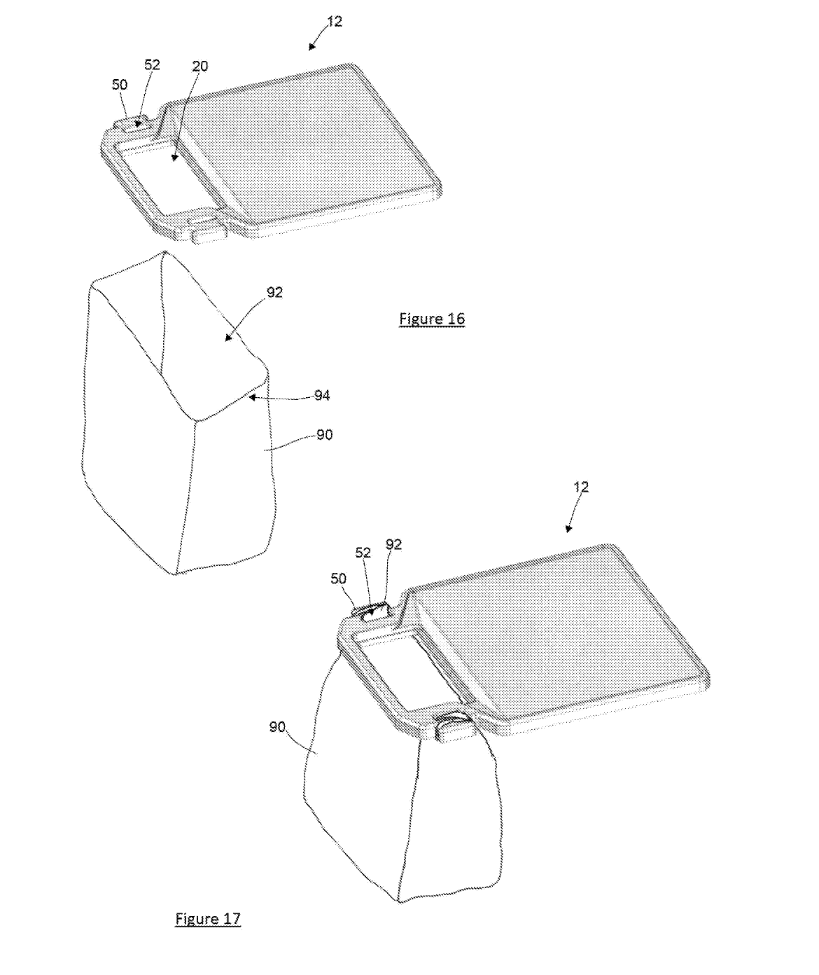

FIGS. 16 and 17 show a handle-less bag 90 such as garbage bag. Portions 94 of the bag 90 from either side of the bag 90 are threaded through the apertures 52. The threaded through portions 94 are then wrapped around and tied down to the anchor formations 50 in an attached condition of the bag 90 as shown in FIG. 17. The handle-less bag 90 has a mouth opening 92

The fastening system of the food preparation board 10 allows a variety of types and sizes of bags to be secured relative to the discharge opening 20. The spacing of the apertures 50 opens the bags 70, 90 a sufficient width to receive the chute 24.

An underside 26 of the food preparation portion 14 of the food preparation board 10 rests on a bench top 88. The discharge portion 16 extends or juts cantilever-fashion from the food preparation portion 16 to overhang the bench top 88. The bag 70, being attached to the food preparation board 10, hangs alongside the bench top 88 from the attachment formations 22.

Food is prepared and chopped on the cutting surface 18. Waste and scraps to be discarded are swept from the cutting surface 18 into the inlet 64 of the chute 24. The waste and scraps travel down the passage 38 of the chute 24 and exit into the bag 70 via the outlet 66 of the chute 24.

The bag 70 containing the waste or scraps is discarded by being released from the food preparation board 10 and thrown into the bin.

The chute 24 can be removed from the body 12 for washing or cleaning.

The food preparation board 10 provides a way to discard waste and scraps without the need for the user to handle the waste and scraps with his or her hands. As a result, the food preparation board 10 can be used in a hygienic manner. The food preparation board 10 allows many types and sizes of disposable bags 70, 90 to be attached to catch waste and scraps from the discharge portion 16 without the user having to hold the bag open. The attachment formations 22 hold the bag 70, 90 open to receive the chute 24. The height of the mouth opening 72 of the bag 70, 90 relative to the underside 26 of the food preparation board 10 is easily adjustable by adjusting the length of the portion of the bag attached to the attachment formations 22.

The user is able to fasten the bag 70, 90 at a height so that the chute 24 extends into the mouth opening 72, 92 of the bag. The chute 24 ensures that scrap or other foodstuff falls into the bag 70, 90. Furthermore, the bag 70, 90 and its contents can be disposed of without further transfer of the contents of the bag 70, 90.

The combination of the attachment formations 22 allowing height adjustability of the bag and the downwardly extending chute 24 provides a sure way for the waste from the cutting surface 18 to be channelled into the bag 70, 90. The food preparation board 10 provides for a continuous passage for waste and scraps from the cutting surface 18 to inside the bag 70, 90, thus precluding waste and scraps from falling, on the floor when being discarded via the discharge opening 20.

The manner in which the bag 70, 90 is attached to the attachment formations 22 makes as much use as possible of any inherent structural integrity that the bag 70, 90 may have. The reason for this is that the portion of the bag passing through the aperture 52 can be wound around the formation 22 or can be twisted into a rope-like form before being fastened or attached to the formations 22. This provides a condition in which the bag is less likely to break than if a handle of the bag was simply hanging from a formation, for example.

It will be appreciated that although the use of the food preparation board 10 has been described in respect of waste and scraps to be discarded, the food preparation board 10 may similarly be used to move chopped food that the user may want to keep from the food preparation board 10 into a bag for storage.

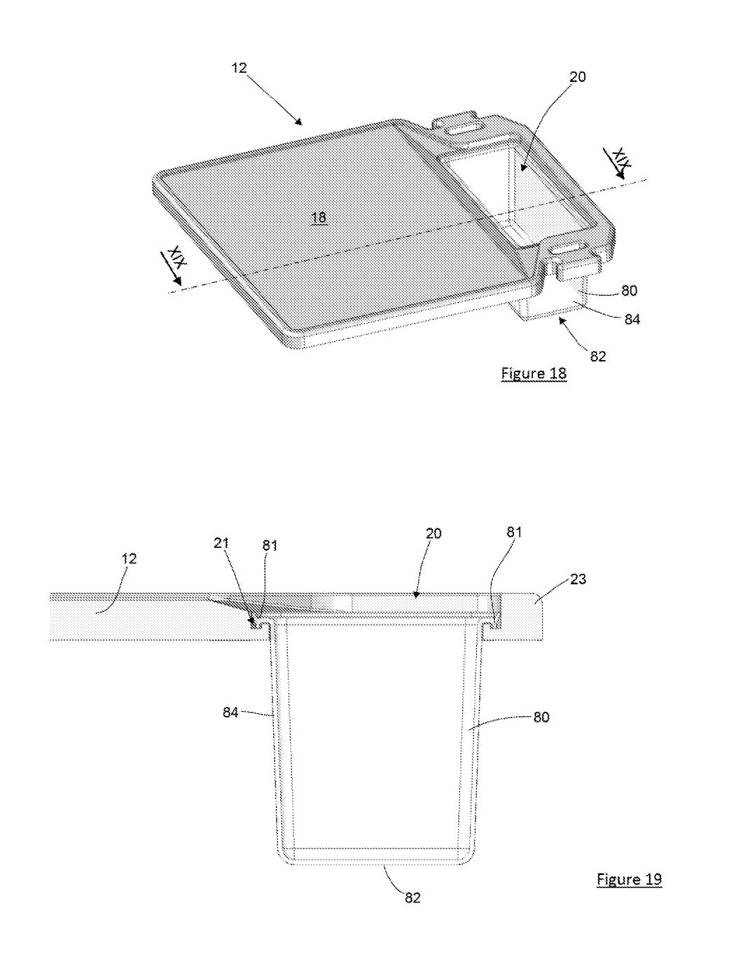

FIGS. 18 and 19 show the use of the food preparation board 10 where the chute 24 is removed and substituted by a receptacle or container 80. The container 80 has a closed bottom 82 so that food can be retained in the container 80. The container 80 comprises rigid sidewalls 84 and a rigid bottom 82. The container 80 seats in the discharge opening 20 of the body 12 in the same manner as the chute 24 seats in the discharge opening 20. The container 80 has flange 81 for resting on the rim 23 of the discharge portion 16.

The user can move food from the cutting surface 18 into the container 80 in the same manner as he/she would have discharged waste or scraps into the bag 70 via the chute 24. The container 80 may include a lid (not shown) for closing off the container 80 for storing the food received therein. The container 80 may be an accessory for the food preparation board 10.

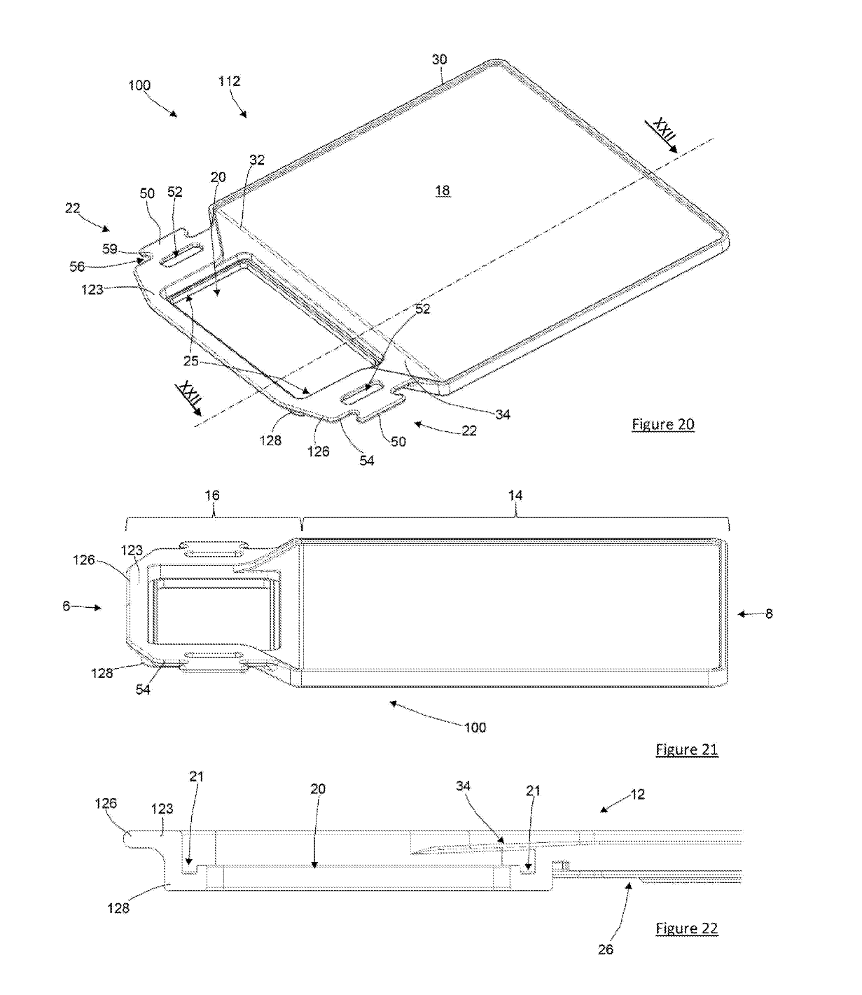

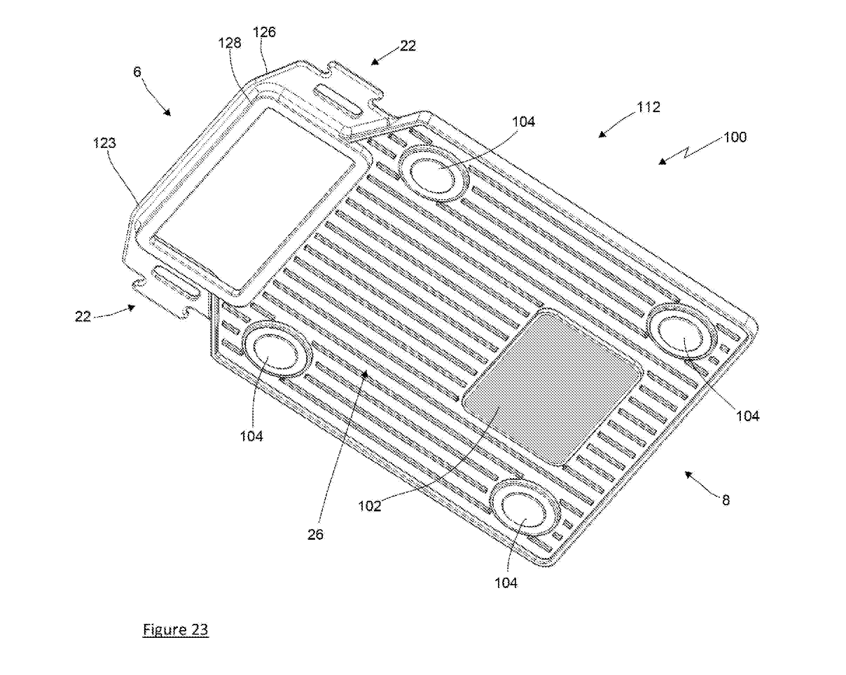

In FIGS. 20 to 23, reference numeral 100 generally indicates another exemplary embodiment of a food preparation board. The food preparation board 100 is similar to the food preparation board 10. The food preparation board 100 comprises a body 112 shown in FIGS. 20 to 23 and the chute 24 which is not shown in FIGS. 20 to 23.

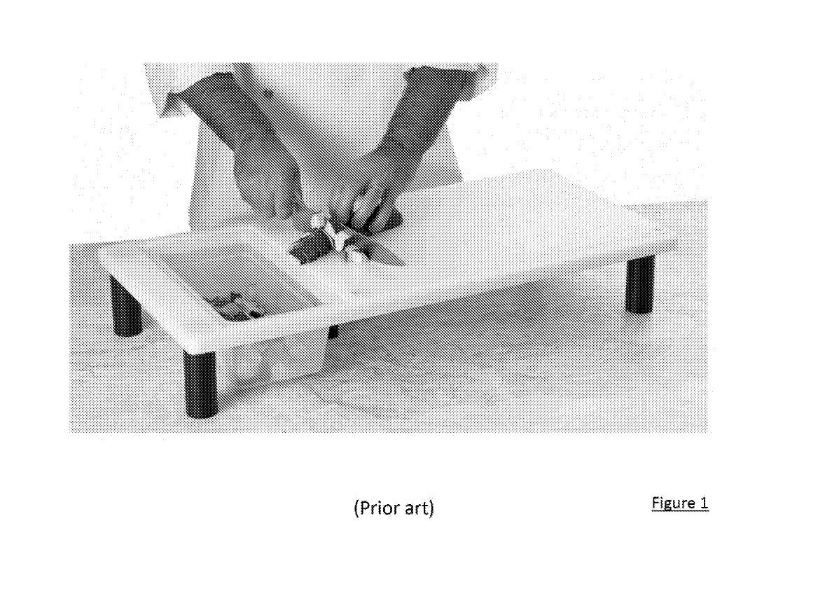

Features of the food preparation board 100 that are the same as the features of the food preparation board 10 are indicated by the same reference numerals in FIGS. 20 to 23 for the food preparation board 100 as they are in FIGS. 1 to 19 for the food preparation board 10. Such use of common reference numerals is not intended to limit the scope of the appended claims.

A rim 123 around the discharge opening 20 of the food preparation board 100 is relatively thin when compared to the rim 23 of the food preparation board 10. The rim 123 comprises a rim surround 126 and a skirt 128. The skirt depends from the surround 126. The groove 21 is formed in the skirt 128 to receive the lip 60 of the chute 24.

The rim 123 is designed to be light in weight due to the discharge portion 16 overhanging the bench top 88 surface, in use.

The food preparation board 100 includes a weight 102 in or on the food preparation portion 14. The weight 102 is shown in the underside 26 of the food preparation portion 14, The weight 102 is located towards the distal end 8 of the food preparation board 100. The weight 102 weighs between 200 g and 600 g, for example 374 g. The weight 102 may be of any suitable material, including steel or stainless steel.

The weight 102 is a counter weight for the discharge portion 16 which overhangs the working surface of the bench top 88. The bag 70, 90 or container 80 and the food or scraps which the bag 70, 90 or container 80 receives when attached to the discharge portion 16 adds weight to the discharge portion 16. The weight 102 assists in preventing the food preparation board from tipping off the bench top as the bag 70, 90 or container 80 is filled.

The underside 26 of the food preparation portion 14 is ribbed for strength.

The food preparation board 100 includes silicone rubber feet 104 to ensure non-slip engagement with the bench top 88 surface. The food preparation board 10 includes metal disks (not shown) under the feet 104, The disks are additional weights to prevent the food preparation board 100 from toppling off the bench top 88, in use. The disks each weigh between 40 g and 100 g, for example 70 g. The disks may be located under the two feet 104 closets to the distal end 8 only, or may be located under each of the four feet 104.

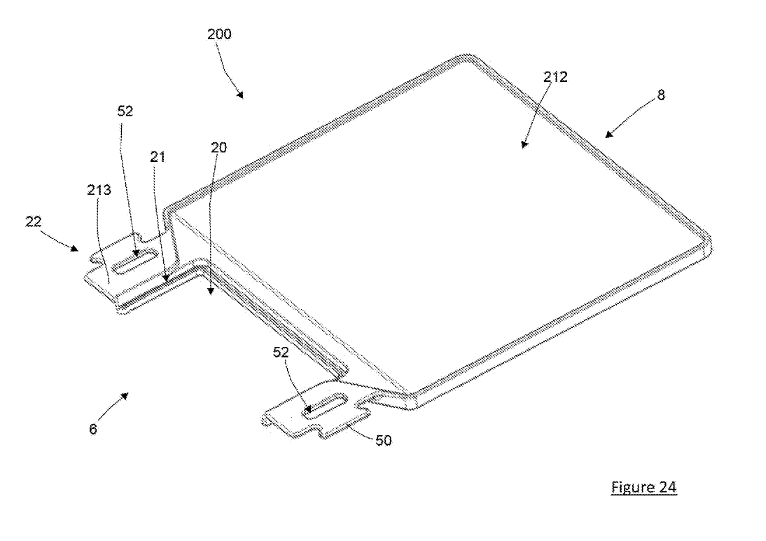

In FIG. 24, reference numeral 200 generally indicates another exemplary embodiment of a food preparation board. The food preparation board 200 is similar to the food preparation board 100. The food preparation board 200 comprises a body 212 shown in FIG. 24 and the chute 24 which is not shown in FIG. 24. The food preparation board 200 is similar to the food preparation 100, the only difference being the rim 213 at the discharge end 6 of the food preparation board 200. The rim 213 of the discharge portion 16 is generally U-shaped. The discharge opening 20 of the body 212 is in the form of a U-shaped recess.

In the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated, No language in the specification should be construed as indicating any non-claimed subject matter as essential to the practice of the claimed subject matter.

The use of words that indicate orientation or direction of travel is not to be considered limiting, Thus, words such as “front”, “back”, “rear”, “side”, “up”, “down”, “upper”, “lower”, “top”, “bottom”, “forwards”, “backwards”, “towards”, “distal”, “proximal”, “in”, “out” and synonyms, antonyms and derivatives thereof have been selected for convenience only, unless the context indicates otherwise. The inventor envisages that various exemplary embodiments of the claimed subject matter can be supplied in any particular orientation and the claimed subject matter is intended to include such orientations.

Thus, regardless of the content of any portion (e.g., title, field, background, summary, description, abstract, drawing figure, etc.) of this application. unless clearly specified to the contrary, such as via explicit definition, assertion, or argument, or clearly contradicted by context, with respect to any claim, whether of this application and/or any claim of any application claiming priority hereto, and whether originally presented or otherwise:
a. there is no requirement for the inclusion of any particular described or illustrated characteristic, function, activity, or element, any particular sequence of activities, or any particular interrelationship of elements;
b. no characteristic, function, activity, or element is “essential”;
c. any elements can be integrated, segregated, and/or duplicated;
d. any activity can be repeated, any activity can be performed by multiple entities, and/or any activity can be performed in multiple jurisdictions; and
e. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values there between, such as for example, 1.1, 2.5, 3.335, 5, 6.179, 8.9999, etc., and includes all subranges there between, such as for example, 1 to 3.65, 2.8 to 8.14, 1.93 to 9, etc.

Accordingly, every portion (e.g., title, field, background, summary, description, abstract, drawing figure. etc.) of this application, other than the claims themselves, is to be regarded as illustrative in nature, and not as restrictive, and the scope of subject matter protected by any patent that issues based on this application is defined only by the claims of that patent.

1. A food preparation board including:
a food preparation portion that defines a surface suitable for supporting food on which food preparation activities are to be performed;
a discharge portion that defines a discharge opening through which food from the surface can be discharged; and
at least two attachment formations about a periphery of the discharge portion, each attachment formation defining an aperture through which a portion of a bag can be threaded and an anchor formation adjacent the aperture, on to which the portion of the bag can be anchored.

2. The food preparation board of claim 1, including a chute that is mounted in the discharge portion in a fixed or removable manner to extend operatively downwardly from the discharge portion, the chute extending into a mouth opening of the bag, in use.

3. The food preparation board of claim 2, wherein the discharge portion is configured so that chute is removably seated in the discharge opening.

4. The food preparation board of claim 1, including a weight in or on the food preparation portion.

5. The food preparation board of claim 3, wherein the chute has a flange for removably seating the chute in the discharge opening.

6. The food preparation board of claim 5, wherein the discharge portion has a rim that is peripheral to the discharge opening, the flange operable to rest on the rim when the chute is seated in the discharge opening. The food preparation board of claim 6, wherein the flange has a downwardly extending lip and the rim has a corresponding groove for receiving the lip.

8. The food preparation board of claim 2, wherein the chute extends to between 30 mm and 90 mm below the discharge portion.

9. The food preparation board of claim 1, wherein each aperture is between the anchor formation and the discharge opening.

10. A food preparation board including:
a food preparation portion that defines a surface suitable for supporting food on which food preparation activities are to be performed;
a discharge portion that defines a discharge opening through which food from the surface can be discharged;
at least two attachment formations about the periphery of the discharge portion, the attachment formations configured for releasable attachment of a bag so that a mouth opening of the bag is open to the discharge opening; and
a chute removably mounted in the discharge portion to extend operatively downwardly from the discharge portion and into the mouth opening of the bag, in use.

11. The food preparation board of claim 10, wherein the chute has a flange for removably seating the chute in the discharge opening.

12. The food preparation board of claim 11, wherein the discharge portion has a rim that is peripheral to the discharge opening, the flange operable to rest on the rim when the chute is seated in the discharge opening.

13. The food preparation board of claim 12, wherein the flange has a downwardly extending lip and the rim has a corresponding groove for receiving the lip.

14. A method of attaching a bag to a food preparation board having a discharge portion that defines a discharge opening through which food can be discharged, the method including:
threading a portion of the bag through an aperture of an attachment formation about a periphery of the discharge portion; and
anchoring the portion of the bag to an anchor formation adjacent the aperture.

15. The method of claim 14, wherein the portion of the bag is looped around the anchor formation.

16. The method of claim 14, wherein the portion of the bag is threaded through the aperture a sufficient extent so that a chute extending operatively downwardly from the discharge portion is received in a mouth opening of the bag.

17. The method of claim 14, wherein the portion of the bag is a bag handle.
